(19) United States
(12) Patent Application Publication
(10) Pub. No.: US 2015/0146577 A1
(43) Pub. Date: May 28, 2015

(54) METHOD AND APPARATUS OF PROVIDING A PROXIMITY-BASED SERVICE

(71) Applicant: LG ELECTRONICS INC., Seoul (JP)

(72) Inventors: Sanggook Kim, Anyang-si (KR); Ki-Dong Lee, Anyang-si (KR)

(73) Assignee: LG ELECTRONICS INC., Seoul (KR)

(21) Appl. No.: 14/405,979

(22) PCT Filed: Jun. 21, 2013
(86) PCT No.: PCT/KR2013/005497

§ 371 Date: Dec. 5, 2014

Related U.S. Application Data
(60) Provisional application No. 61/662,872, filed on Jun. 21, 2012.

(51) Int. Cl. H04W 4/08; H04W 12/08; H04W 8/00; H04W 4/22; H04W 4/02

(52) U.S. Cl. CPC H04W 4/08; H04W 4/22; H04W 4/02; H04W 8/005; H04W 12/08
USPC 370/259

(57) ABSTRACT

The present invention is directed to a method and an apparatus for use in a wireless communication system. Specifically, the present invention is directed to a method and an apparatus of performing a procedure of forming a Public Safety Group (PSG) for a Proximity-based Service (ProSe), the method comprising: receiving first information indicating one or more class identifiers as a part of system information from a network; determining whether any one of one or more configured class identifiers is indicated to be used as a specific class identifier for the PSG formation based on the first information in the system in formation; and performing a procedure to discover one or more neighboring user equipments for PSG formation using the specific identifier when any one of the one or more configured class identifiers are indicated as the specific class identifier for the PSG information.

### TECHNICAL FIELD

The present invention is directed to a method and an apparatus for use in a wireless communication system. Specifically, the present invention is directed to a method and an apparatus of providing a Proximity-based Service (ProSe), in particular a ProSe with Restricted Public safety Group (RPG).

### BACKGROUND ART

Generally, a wireless communication system is being developed to diversely cover a wide range to provide such communication services as an audio communication service, a data communication service and the like. The wireless communication is a sort of a multiple access system capable of supporting communications with multiple users by sharing available system resources (e.g., bandwidth, transmit power, etc:). For example, the multiple access system may include one of a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, a Multi Carrier Frequency Division Multiple Access (MC-FDMA) and the like.

### DISCLOSURE

### Technical Problem

An object of the present invention is to provide a method and an apparatus of efficiently providing a Proximity-based Service (ProSe), in particular a ProSe with Restricted Public safety Group (RPG). Another object of the present invention is to provide a method and an apparatus of efficiently forming RPG.

It will be appreciated by persons skilled in the art that the objects that can be achieved through the present invention are not limited to what has been particularly described hereinabove and the above and other objects that the present invention can achieve will be more clearly understood from the following detailed description taken in conjunction with the accompanying drawings.

### Technical Solution

As an aspect of the present invention, a method of performing a procedure of forming one or more Public Safety Groups (PSGs) for a Proximity-based Service (ProSe) at a User Equipment (UE) is provided, wherein the UE has one or more configured class identifiers for the PSG, and the method comprises: receiving first information indicating one or more class identifiers as a part of system information from a network; determining whether any one of the one or more configured class identifiers is indicated to be used as a specific class identifier for the PSG formation based on the first information in the system information; and performing a procedure to discover one or more neighboring UEs for PSG formation using the specific identifier when any one of the one or more configured class identifiers is indicated as the specific class identifier for the PSG formation.

Preferably, the first information may be received from a control entity related to public safety via a base station and the like.

Preferably, the method further comprises: transmitting information about one or more discovered neighboring UEs to the control entity related to public safety via the base station and the like.

Preferably, the first information may include a bit map in which each bit is reserved for a corresponding class identifier, and one or more class identifiers corresponding to one or more bits set to a specific value are specific class identifiers for the PSG formation.

Preferably, the first information may indicate a class identifier, and one or more class identifiers higher or lower than the class identifier in the system information are specific class identifiers for the PSG formation.

Preferably, the method further comprises: receiving second information indicating one or more group identifiers used to identify one or more PSGs, wherein two or more members of distinct PSGs communicate using the one or more group identifiers.

Preferably, the method further comprises: receiving third information including identification information on one or more specific UEs for each PSG, wherein each of the one or more specific UEs acts as a leader of a corresponding PSG.

Preferably, the method further comprises: receiving fourth information indicting one or more authorization levels, wherein each authorization level is defined for a corresponding class identifier or a UE. The authorization level may include the indication of the application/service level that is allowed for the PSG.

As another aspect of the present invention, a UE configured to perform a procedure of forming one or more Public Safety Groups (PSGs) for a Proximity-based Service (ProSe) is provided, wherein the UE has one or more configured class identifiers for the PSG, and the UE comprises: a radio frequency (RF) unit; and a processor, wherein the processor is configured: to receive first information indicating one or more class identifiers as a part of system information from a network, to determine whether any one of the one or more configured class identifiers is indicated to be used as a specific class identifier for the PSG formation based on the first information in the system information, and to perform a procedure to discover one or more neighboring UEs for PSG formation using the specific identifier when any one of the one or more configured class identifiers is indicated as the specific class identifier for the PSG formation.

Preferably, the first information may be received from a control entity related to public safety via a base station and the like.

Preferably, the processor may be further configured to: transmit information about one or more discovered neighboring UEs to the control entity related to public safety via the base station and the like.

Preferably, the first information may include a bit map in which each bit is reserved for a corresponding class identifier, and one or more class identifiers corresponding to one or more bits set to a specific value are specific class identifiers for the PSG formation.

Preferably, the first information may indicate a class identifier, and one or more class identifiers higher than the class identifier in the system information are specific class identifiers for the PSG formation.

Preferably, the processor may be further configured to: receive second information indicating one or more group identifier used to identify one or more PSGs, wherein two or more members of distinct PSGs communicate using the one or more group identifiers.

Preferably, the processor may be further configured to: receive third information including identification information on one or more specific UEs for each PSG, wherein each of the one or more specific UEs acts as a leader of a corresponding PSG.

Preferably, the processor may be further configured to: receive fourth information indicting one or more authorization levels, wherein each authorization level is defined for a corresponding class identifier or a mobile device. The authorization level may include the indication of the application/service level that is allowed for the PSG.

### Advantageous Effects

Exemplary embodiments of the present invention have the following effects. In accordance with the embodiments of the present invention, a Proximity-based Service (ProSe), in particular a ProSe with Restricted Public safety Group (RPG) may be efficiently provided. In addition, RPG may be efficiently formed.

It will be appreciated by persons skilled in the art that the effects that can be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 illustrates a network structure of an Evolved Universal Mobile Telecommunication System (E-UMTS).

FIG. 2 illustrates a general functional structure of a typical E-UTRAN and that of a typical Evolved Packet Core (EPC).

FIGS. 3a˜3b illustrate a user-plane protocol and a control-plane protocol stack for the E-UMTS network

FIG. 4 illustrates a downlink subframe and physical channels.

FIG. 5 illustrates a contention-based Random Access (RA) procedure.

FIG. 6 illustrates an example of data path for a typical (i.e., non-proximity) communication.

FIGS. 7˜8 illustrate examples of data path scenarios for a proximity communication.

FIG. 9˜13 illustrates signal flow diagrams of RPG forming procedures in accordance with the present invention.

FIG. 14 illustrates a block diagram of a UE or Mobile Station (MS).

### MODE FOR INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following embodiments of the present invention can be applied to a variety of wireless access technologies, for example, CDMA, FDMA, TDMA, OFDMA, SC-FDMA, MC-FDMA, and the like. CDMA can be implemented by wireless communication technologies, such as Universal Terrestrial Radio Access (UTRA) or CDMA2000. TDMA can be implemented by wireless communication technologies, for example, Global System for Mobile communications (GSM), General Packet Radio Service (GPRS), Enhanced Data rates for GSM Evolution (EDGE), etc. OFDMA can be implemented by wireless communication technologies, for example, IEEE 802.11 (Wi-Fi), IEEE 802.16 (WiMAX), IEEE 802.20, E-UTRA (Evolved UTRA), and the like. UTRA is a part of the Universal Mobile Telecommunications System (UMTS). 3rd Generation Partnership Project (3GPP) Long Term Evolution (LTE) is a part of Evolved UMTS (E-UMTS) that uses E-UTRA. The LTE-Advanced (LTE-A) is an evolved version of 3GPP LTE. Although the following embodiments of the present invention will hereinafter describe inventive technical characteristics on the basis of the 3GPP LTE/LTE-A system, it should be noted that the following embodiments will be disclosed only for illustrative purposes and the scope and spirit of the present invention are not limited thereto.

Specific terms used for the exemplary embodiments of the present invention are provided to aid in understanding of the present invention. These specific terms may be replaced with other terms within the scope and spirit of the present invention.

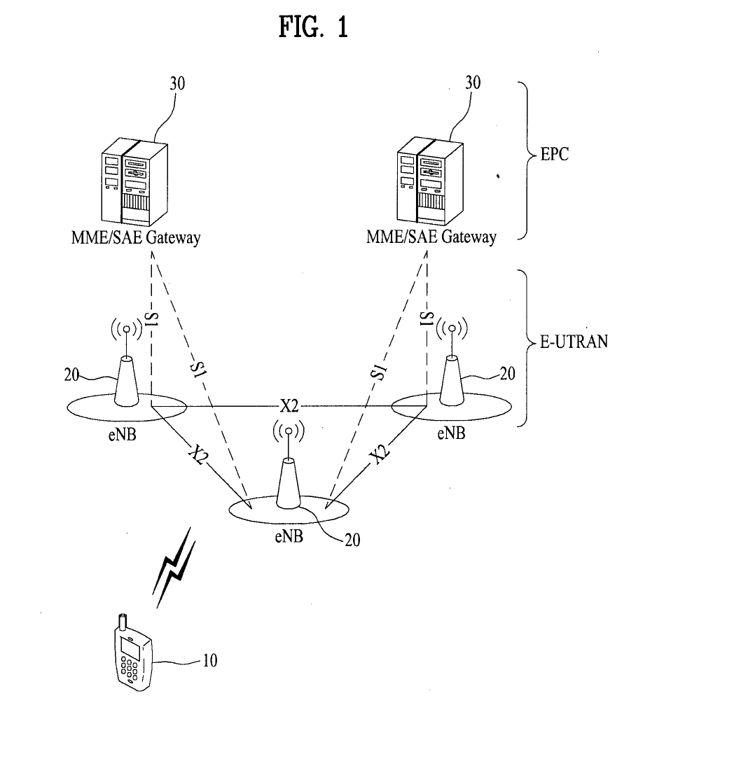

FIG. 1 illustrates a network structure of an E-UMTS. The E-UMTS may be also referred to as an LTE system. The E-UMTS is widely deployed to provide a variety of communication services such as voice and packet data, and is generally configured to function based upon the various techniques presented herein and discussed in more detail with regard to later figures.

With reference to FIG. 1, the E-UMTS network includes an Evolved UMTS Terrestrial Radio Access Network (E-UTRAN), an Evolved Packet Core (EPC), and one or more mobile terminals. (or User Equipment (UE)) 10. The E-UTRAN includes one or more eNodeBs (eNBs) 20. Regarding the EPC, Mobility Management Entity/System Architecture Evolution (MME/SAE) gateway 30 provides an end point of a session and mobility management function for the UE 10. The eNB 20 and the MME/SAE gateway 30 may be connected via an S1 interface.

The UE 10 is a communication device carried by a user and may also be referred to as a Mobile Station (MS), a User Terminal (UT), a Subscriber Station (SS) or a wireless device. In general, the UE includes a transmitter and processor, among other components, and is configured to operate in accordance with the various techniques presented herein.

The eNB 20 is generally a fixed station that communicates with the UE 10. In addition to being referred to as a base station, the eNB 20 may also be referred to as an access point. An eNB 20 provides end points of a user plane and a control plane to the UE 10. In general, the eNB includes a transmitter and processor, among other components, and is configured to operate in accordance with the various techniques presented herein.

A plurality of UEs 10 may be located in one cell. One eNB 20 is typically deployed per cell. An interface for transmitting user traffic or control traffic may be used between eNBs 20. Here, “DownLink (DL)” refers to communication from the eNB 20 to the UE 10, and “UpLink (UL)” refers to communication from the UE to the eNB.

The MME gateway 30 provides various functions including distribution of paging messages to eNBs 20, security control, idle state mobility control, SAE bearer control, and ciphering and integrity protection of Non-Access Stratum (NAS) signaling. The SAE gateway 30 provides assorted functions including termination of U-plane packets for paging reasons, and switching of the U-plane to support UE mobility.

A plurality of nodes may be connected between eNB 20 and gateway 30 via the S1 interface. The eNBs 20 may be connected to each other via an X2 interface and neighboring eNBs may have a meshed network structure that has the X2 interface.

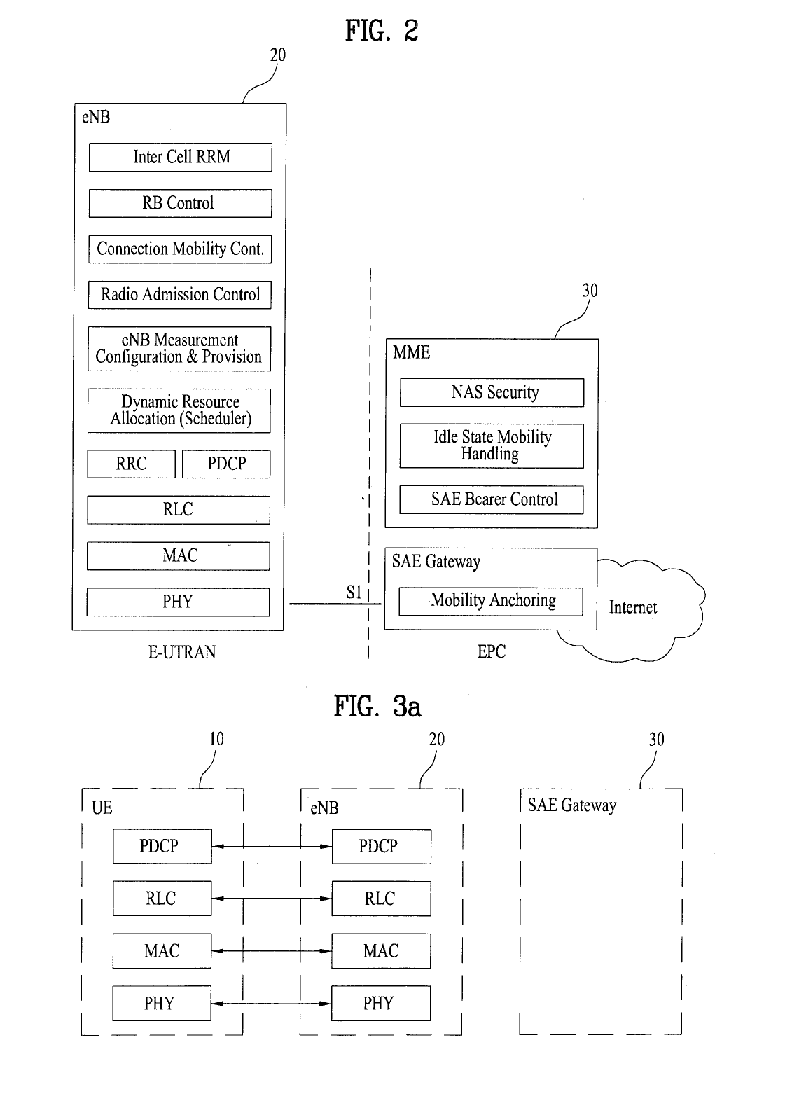

FIG. 2 is a block diagram depicting general functional structures of an E-UTRAN and a EPC. With reference to FIG. 2, eNB 20 may perform functions of selection for MME/SAE gateway 30, routing toward the gateway during a Radio Resource Control (RRC) activation, scheduling and transmitting of paging messages, scheduling and transmitting of Broadcast Control Channel (BCCH) information, dynamic allocation of resources to UEs 10 in both uplink and downlink, configuration and provisioning of eNB measurements, radio bearer control, Radio Admission Control (RAC), and connection mobility control in LTE_ACTIVE state.

In the EPC, and as described above, MME/SAE gateway 30 may perform functions of paging origination, LTE-IDLE state management, ciphering of the user plane, SAE bearer control, and ciphering and integrity protection of NAS signaling.

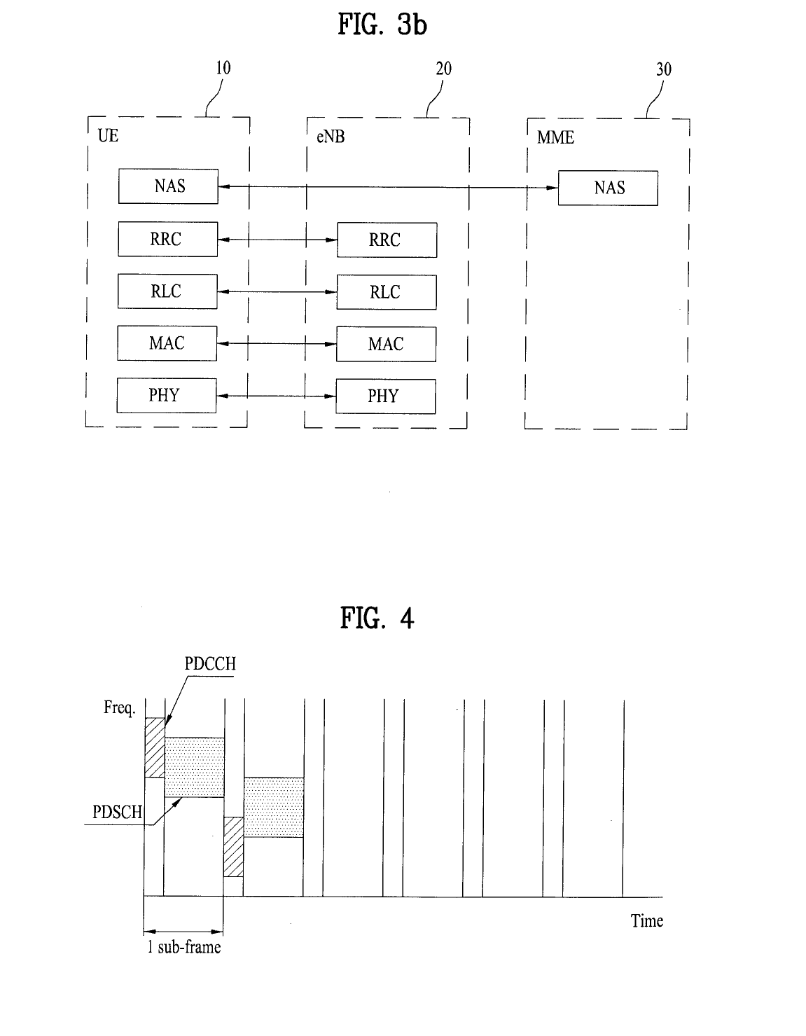

FIGS. 3a˜3b illustrate the user-plane protocol and the control-plane protocol stack for the E-UMTS network. With reference to FIGS. 3a˜3b, the protocol layers may be divided into a first layer (L1), a second layer (L2) and a third layer (L3) based upon the three lower layers of an Open System Interconnection (OSI) standard model as known in the art of communication systems.

The first layer L1 (or the physical layer) provides an information transmission service to an upper layer using a physical channel. The physical layer is connected with a Medium Access Control (MAC) layer through a transport channel, and data between the MAC layer and the physical layer are transferred via the transport channel. Between different physical layers, namely, between physical layers of a transmission side and a reception side (for example, between physical layers of UE 10 and eNB 20), data are transferred via the physical channel.

The MAC layer of Layer 2 (L2) provides services to a Radio Link Control (RLC) layer via a logical channel. The RLC layer of Layer 2 (L2) supports a reliable transmission of data. Although the RLC layer is shown in FIGS. 3a˜3b as being separate from the MAC layer, it is understood that the functions of the RLC layer may be performed by the MAC layer and that, therefore, a separate RLC layer is not required. With reference to FIG. 3a, the Packet Data Convergence Protocol (PDCP) layer of Layer 2 (L2) performs a header compression function that reduces unnecessary control information such that data being transmitted by employing Internet Protocol (IP) packets, such as IPv4 or IPv6, can be efficiently sent over a radio (wireless) interface that has a relatively narrow bandwidth.

With reference to FIG. 3b, a Radio Resource Control (RRC) layer located at the lowest portion of the third layer (L3) is typically only defined in the control plane and controls logical channels, transport channels and the physical channels in relation to the configuration, reconfiguration, and release of the Radio Bearers (RBs). Here, the RB means a service provided by the second layer (L2) for data transmission between the terminal and the E-UTRAN.

With reference to FIG. 3a, the RLC and MAC layers (terminated in an eNB 20 on the network side) may perform functions such as Scheduling, Automatic Repeat reQuest (ARQ), and Hybrid Automatic Repeat reQuest (HARQ). The PDCP layer (terminated in eNB 20 on the network side) may perform the user plane functions such as header compression, integrity protection, and ciphering.

With reference to FIG. 3b, the RLC and MAC layers (terminated in an eNB 20 on the network side) perform the same or similar functions as for the control plane. The RRC layer (terminated in an eNB 20 on the network side) may perform functions such as broadcasting, paging, RRC connection management, RB control, mobility functions, and UE measurement reporting and controlling. The NAS control protocol (terminated in the MME 30 on the network side) may perform functions such as a SAE bearer management, authentication, LTE_IDLE mobility handling, paging origination in LTE_IDLE, and security control for the signaling between the gateway and UE 10.

The NAS control protocol may use three different states: first, a LTE_DETACHED state if there is no RRC entity; second, a LTE_IDLE state if there is no RRC connection while storing minimal UE information; and third, an LTE_ACTIVE state if the RRC connection is established.

Thus RRC state may be divided into two different states such as an RRC_IDLE state and an RRC_CONNECTED state. In the RRC_IDLE state, the UE 10 may receive broadcasts of system information and paging information while the UE specifies a Discontinuous Reception (DRX) configured by NAS, and the UE has been allocated an identification (ID) (e.g., System Architecture Evolution-Temporary Mobile Subscriber Identity (S-TMSI)) which uniquely identifies the UE in a tracking area. Also, in the RRC-IDLE state, no RRC context is stored in the eNB.

In the RRC_IDLE state, the UE 10 specifies the paging DRX (Discontinuous Reception) cycle. Specifically, the UE 10 monitors a paging signal at a specific paging occasion of every UE specific paging DRX cycle.

In the RRC_CONNECTED state, the UE 10 has an E-UTRAN RRC connection and a RRC context is stored in the E-UTRAN, such that transmitting and/or receiving data to/from the network (eNB) becomes possible. Also, the UE 10 can report channel quality information and feedback information to the eNB.

In RRC_CONNECTED state, the E-UTRAN knows the cell to which the UE 10 belongs. Therefore, the network can transmit and/or receive data to/from UE 10, the network can control mobility (handover) of the UE.

FIG. 4 illustrates a downlink subframe and physical channels.

With reference to FIG. 4, the downlink subframe includes a plurality of slots (e.g., two). The number of OFDM symbols included in one slot may be changed according to the length of a Cyclic Prefix (CP). For example, in case of a normal CP, the slot may include seven OFDM symbols. The downlink subframe is divided into a data region and a control region in a time domain. A maximum of three (or four) OFDM symbols located in the front part of a first slot of the subframe may correspond to a control region to which a control channel is allocated. The remaining OFDM symbols correspond to a data region to which a Physical Downlink Shared Channel (PDSCH) is allocated. A variety of downlink control channels may be used in LTE/LTE-A, for example, a Physical Control Format Indicator Channel (PCFICH), a Physical Downlink Control Channel (PDCCH), a Physical Hybrid ARQ Indicator Channel (PHICH), etc. The PCFICH is transmitted on the first OFDM symbol of the subframe, and carries information about the number of OFDM symbols used for transmitting control channels within the subframe. The PHICH carries a Hybrid Automatic Repeat reQuest Acknowledgment/Negative-Acknowledgment (HARQ ACK/NACK) signal as a response to an uplink transmission signal.

Control information transmitted over a PDCCH is referred to as Downlink Control Information (DCI). DCI includes resource allocation information for either a UE or a UE group and other control information. For example, DCI includes UL/DL scheduling information, an UL transmission (Tx) power control command, etc.

The PDCCH carries a variety of information, for example, transmission format and resource allocation information of a DownLink Shared Channel (DL-SCH), transmission format and resource allocation information of an UpLink Shared Channel (UL-SCH), paging information transmitted over a Paging Channel (PCH), system information transmitted over the DL-SCH, resource allocation information of an upper-layer control message such as a random access response transmitted over PDSCH, a set of Tx power control commands of each UE contained in a UE group, a Tx power control command, activation indication information of Voice over IP (VoIP), and the like. A plurality of PDCCHs may be transmitted within a control region. A UE can monitor a plurality of PDCCHs. A PDCCH is transmitted as an aggregate of one or more contiguous Control Channel Elements (CCEs). The CCE is a logical allocation unit that is used to provide a coding rate based on a radio channel state to a PDCCH. The CCE may correspond to a plurality of Resource Element Groups (REGs). The format of PDCCH and the number of PDCCH bits may be determined according to the number of CCEs. A Base Station (BS) decides a PDCCH format according to DCI to be sent to the UE, and adds a Cyclic Redundancy Check (CRC) to control information. The CRC is masked with an identifier (e.g., Radio Network Temporary Identifier (RNTI)) according to a PDCCH owner or a purpose of the PDCCH. For example, provided that the PDCCH is provided for a specific UE, a CRC may be masked with an identifier of the corresponding UE (e.g., cell-RNTI (C-RNTI)). If PDCCH is provided for a paging message, a CRC may be masked with a paging identifier (e.g., Paging-RNTI (P-RNTI)). If a PDCCH is provided for system information (e.g., System Information Block (SIB)), a CRC may be masked with system Information RNTI (SI-RNTI). If PDCCH is provided for a random access response, a CRC may be masked with Random Access-RNTI (RA-RNTI). For example, CRC masking (or scrambling) may be performed using an exclusive OR (XOR) operation between CRC and RNTI at a bit level.

To initiate access to the network, a random access procedure is used. The random access procedure is also referred to as a Random Access Channel (RACH) procedure. Physical Random Access Channel (PRACH) transmission is under control of higher layer protocol which performs some important functions related to priority and load control. The PRACH is a common physical channel dedicated to the random access procedure. There are two kinds of RACH procedures: contention-based RACH procedure and non-contention-based RACH procedure. In the contention-based RACH procedure, many UEs can attempt to access the same base station simultaneously using same RACH preamble/resources, which may lead to network access congestions/collisions. Hereinafter, unless mentioned otherwise, a RACH (or RA) procedure means a contention-based RACH (or RA) procedure.

A RACH procedure can be used for several purposes. For example the RACH procedure can be used to access the network, to request resources, to carry control information, to adjust the time offset of the uplink in order to obtain uplink synchronization, to adjust the transmitted power, etc.

A RACH procedure can be initiated by the UE or the eNB. The RACH procedure may, for instance, be triggered by the following events:
A UE switches from power-off to power-on and needs to be registered to the network.
A UE is not time-synchronized with a eNB and starts transmitting data (for instance the user calls).
An eNB starts transmitting data to the UE but they are not synchronized (for instance the user receives a call).
An eNB measures a delay of the received signal from the UE (for instance the user is moving and has lost synchronization).

FIG. 5 illustrates a contention-based random access procedure.

With reference to FIG. 5, firstly the UE retrieves information transmitted periodically from eNB on a downlink Broadcast Channel (BCH) and selects a preamble signature (e.g., Constant Amplitude Zero Auto-Correlation (CAZAC) sequence), a RACH time slot and a frequency band. The preamble signature is chosen by the UE from among a set of signatures known by the eNB. The UE generates a random access preamble (message 1, box 1) containing the chosen signature and transmits it to the eNB over the selected time slot at the selected frequency. The random access preamble is sent before a RACH connection request and indicates that the UE is about to transmit data. During the random access procedure, several UEs may share the same RACH channel (i.e., PRACH) and they are distinguished by preamble signatures. Congestions/collisions occur whenever several UEs choose the same signature and send it within the same time and frequency resources.

The eNB monitors the current RACH slot in an attempt to detect preambles transmitted from UEs in a corresponding cell. On reception of a signal, the eNB correlates the received signal in the RACH subframe with all possible signatures. Detection of the preamble can be either performed in the time domain or in the frequency domain. A detection variable is computed for each signature. If the detection variable exceeds a certain threshold, the preamble is considered detected.

The eNB sends a random access response (message 2, box 2) to acknowledge the successfully detected preambles. The random access response is sent via a downlink shared channel and includes the detected signature. The random access response also contains a timing advance command, a power-control command.

If the UE receives a random access response from the eNB, the UE decodes the random access response and adapts UL transmission timing, and UL transmission power if the random access response contains power control information. The UE then sends a resource request message (message 3, box 3) via an uplink shared channel. In the message 3, the UE requests bandwidth and time resources to transmit data and it also indicates a UE-specific identifier. When the UE requests resources, the UE uses a specific ID in the message 3 to resolve contentions. Then the UE monitors a specified downlink channel for response from the eNB. In the case of a positive resource grant, the subsequent transmissions are carried out as normal.

The eNB attempts to resolve any contentions. If the eNB receives a resource request with a UE-specific signature, the eNB checks how many UEs were detected with the same signature and resolves any possible contentions. If the preamble sent by a UE was in collision with a preamble from another UE, the eNB sends a contention resolution message (message 4, box 4) to command a corresponding UE to re-start the RACH procedure. If the UE was not in collision, the eNB sends a resource assignment message (message 5, box 5). Subsequent transmissions are carried out as usual.

Recently, Proximity-based Service (ProSe) has been discussed in 3GPP. The ProSe enables different UEs to be connected (directly) each other (after appropriate procedure(s), such as authentication), through eNB only (but not further through Serving Gateway (SGW)/Packet Data Network Gateway (PDN-GW, PGW)), or through SGW/PGW. The ProSe has various use cases and potential requirements for an operator network controlled discovery and communications between wireless devices that are in proximity, under continuous network control, and are under a 3GPP network coverage, for:
Commercial/social use
Network offloading
Public Safety
Integration of current infrastructure services, to assure the consistency of the user experience including reachability and mobility aspects
Public Safety, in case of absence of E-UTRAN coverage (subject to regional regulation and operator policy, and limited to specific public-safety designated frequency bands and terminals)

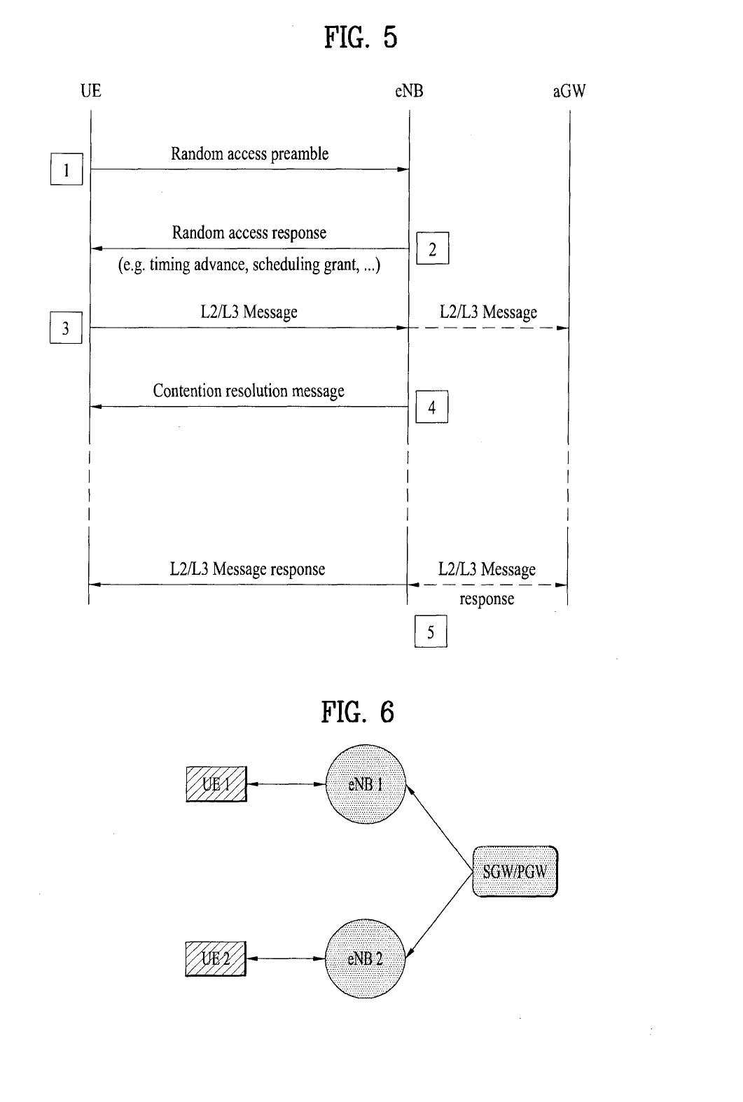

FIG. 6 illustrates an example of data path for a typical (i.e., non-proximity) communication between two UEs. With reference to FIG. 6, even when two UEs (e.g., UE1, UE2) in close proximity communicate with each other, their data path (user plane) goes via the operator network. Thus a data path for the typical communication involves eNB(s) and/or Gateway(s) (GW(s)) (e.g., SGW/PGW).

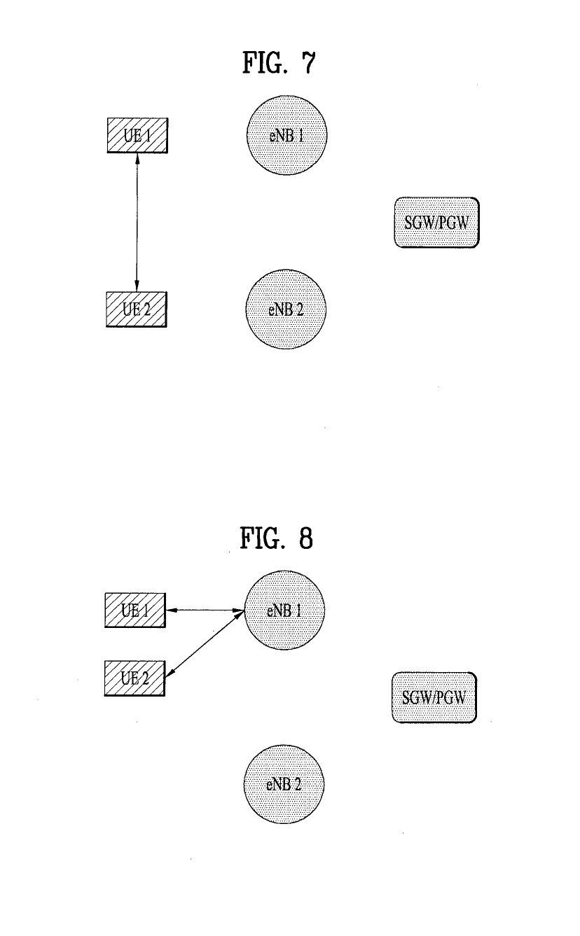

FIGS. 7˜8 illustrate examples of data path scenarios for a proximity communication. If wireless devices (e.g., UE1, UE2) are in proximity of each other, they may be able to use a direct mode data path (FIG. 7) or a locally routed data path (FIG. 8). In the direct mode data path, wireless devices are connected directly each other (after appropriate procedure(s), such as authentication), without eNB and SGW/PGW. In the locally routed data path, wireless devices are connected each other through eNB only.

Example: Closed ProSe Group

ProSe is very useful services for public safety UEs such that they can efficiently handle situations that require public safety personnel's involvement. However, discovery and communications among all public safety UEs in a certain situation could increase complexity, introduce stability concern of connections, and thus can provide less efficiency than being conceived. Possible example is a fire situation in downtown New York within network coverage. In order to manage the situation under control, it is better for the public safety UEs that belong to only policemen and firemen to form a ProSe group such that the public safety UEs that belong to, for example, immigration officers in the scene can be excluded from ProSe discovery and communications.

In order to address above problems, the present invention proposes various methods for forming a closed ProSe group and performing communication between closed ProSe groups. The closed ProSe group can be interchanged with equivalent terms such as Restricted Public safety Group (RPG). Here, the closed ProSe group or RPG means a group of public safety ProSe UEs where one of those UE's can discover and be discoverable by others in the same closed ProSe group or RPG but cannot be discovered by anyone out of the group. And, Restricted Public safety Mode (RPM) means an operational mode where RPG is constituted.

Procedure for Forming an RPG

The procedure for forming an RPG requires “ProSe discovery”. Here, it is proposed and described how ProSe-enabled Public Safety UEs can discover each other using signaled information (e.g., by a central control entity) or subscription/profile.

The following set of situations, or pre-condition, is one of possible examples that the proposed method for forming an RPG can be applied.

TABLE 1
1. Public safety UE has a class identifier(s):

| | |
|---|---|
| a. | May be based on the department it belongs to, for example, class |
| | identifier #1 for police department, class identifier #2 for fire |
| | department, and etc. |
| b. | May be based on the hierarchical order of urgency. For example, |
| | class #1 for the set #1 of urgency situations, class #2 for the set #2 |
| | of urgency situations, and etc. |
| c. | May be hard-coded into public safety UE and/or placed into |
| | identity module, e.g., SIM. |
| d. | May be semi-statically or dynamically configured using a network |
| | notification. |

2. Central control entity knows the situations and locations that require
public safety personnel's involvement.

Network-Based Method

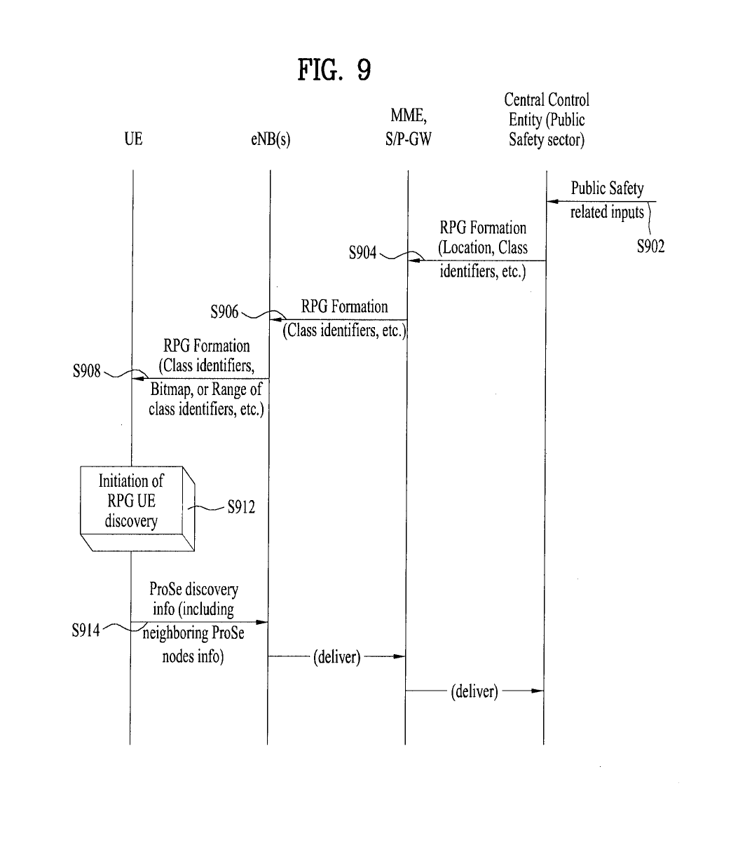

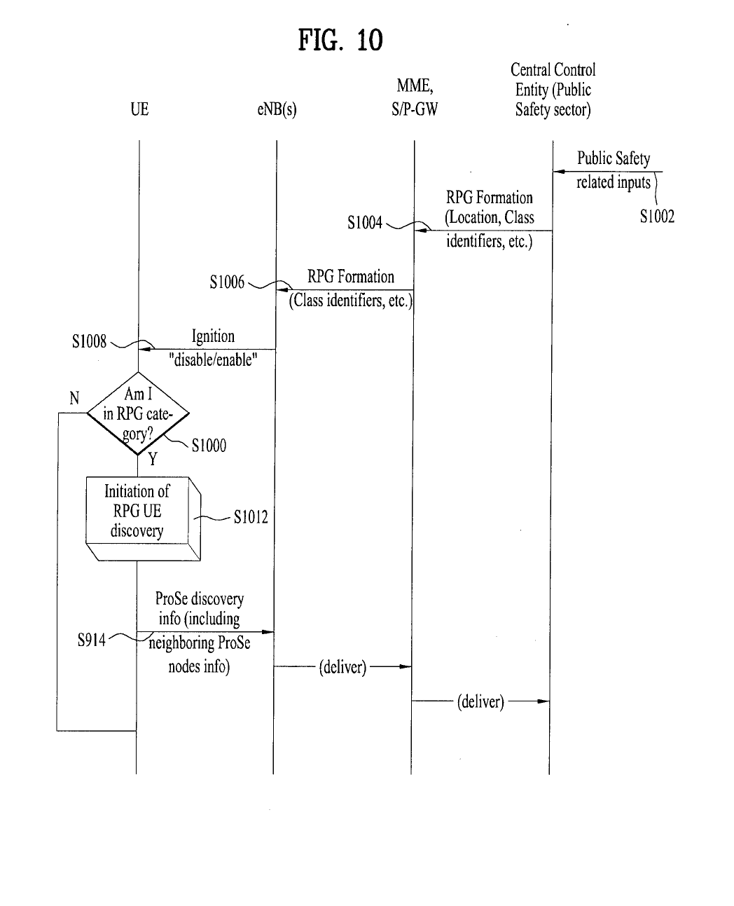

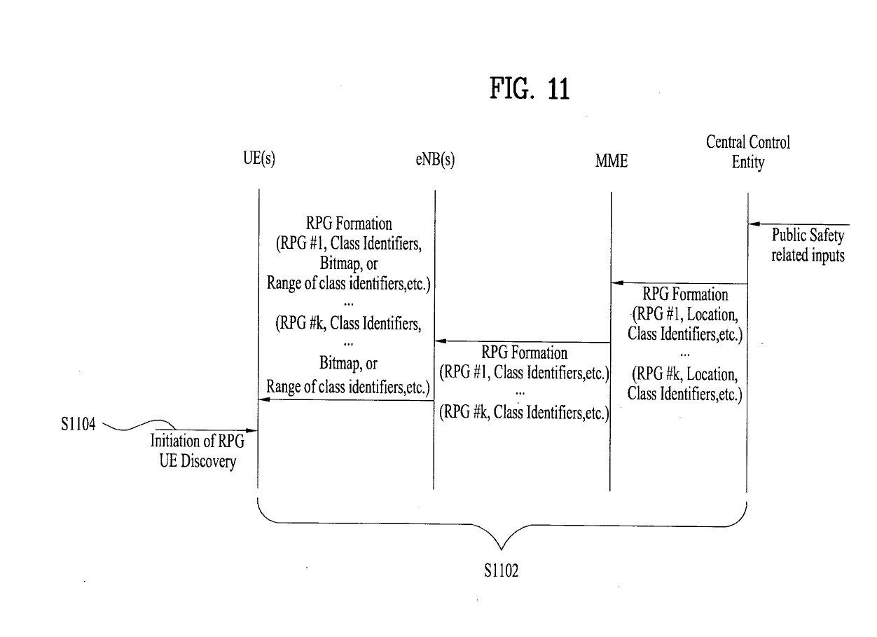

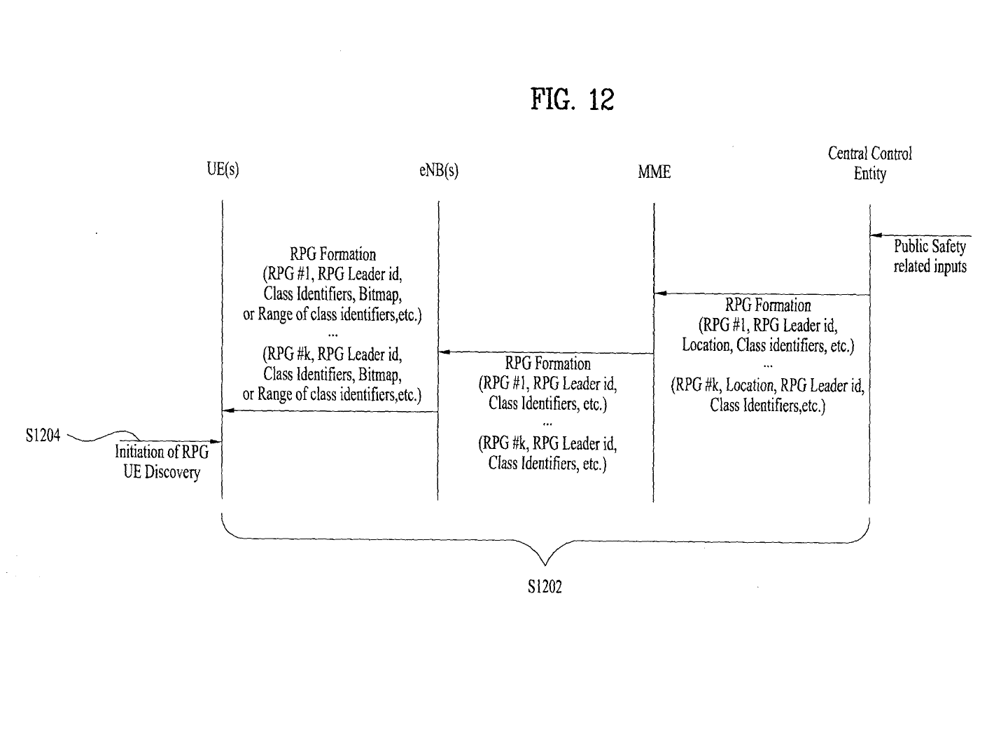

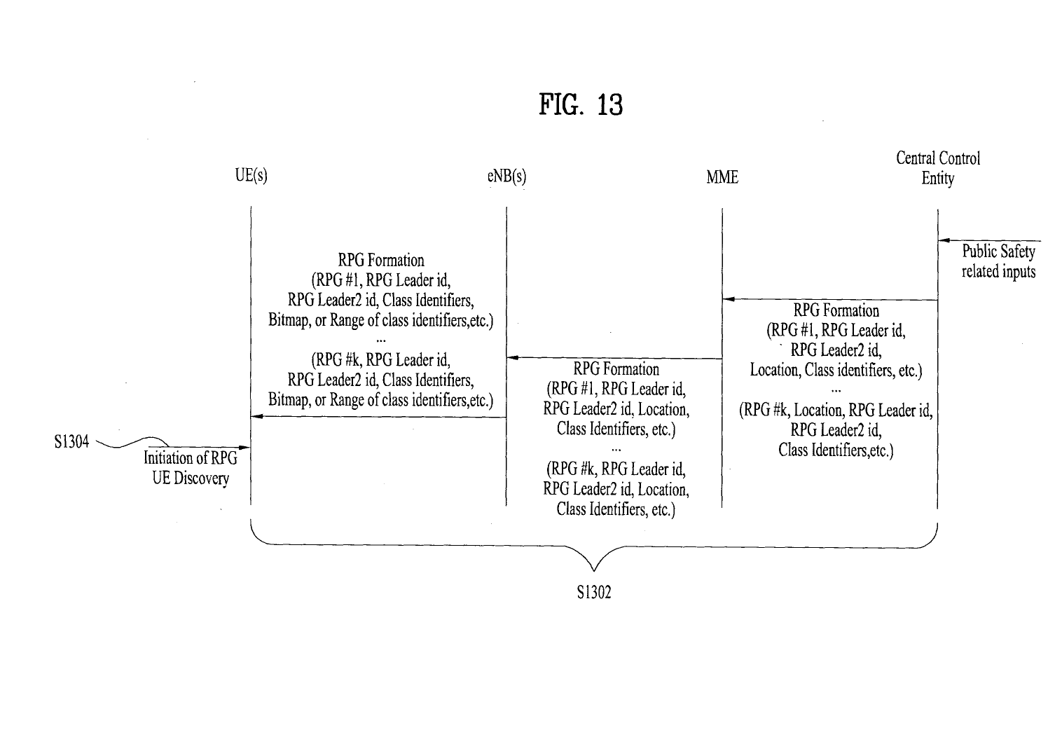

FIG. 9 illustrates a signal flow diagram of RPG forming procedure in accordance with an example of the present invention.

With reference to FIG. 9, a central control entity (e.g., public safety sector) may receive information (in FIG. 9, Public Safety-related inputs) on public safety situation within a certain geographical area (S902). The information on public safety situation may include, for example, information indicating a situation (e.g., fire, robbery, terror) and information indicating a location. Then, the central control entity may provide at least part of the information on public safety situation, as a part of a request message (hereinafter, RPG formation request #1), to public safety network entities (e.g., Mobility Management Entity, MME) to form a closed ProSe group over the region. The RPG formation request #1 may further include information related to class identifier. Then the MME may deliver at least part of RPG formation request #1, as a part of a request message (hereinafter, RPG formation request #2), to public safety radio entities (e.g., eNB) over the region (or broadcast over the entire network coverage) to form an RPG for the situation. The RPG formation request #2 may be delivered using a broadcast message and/or an overhead message (e.g., system parameter message, System Information Block (SIB), etc.).

The RPG formation request #2 may include class identifier information. The class identifier information may be used to indicate which ProSe-enabled UE(s) constitutes the RPG. As an example, the class identifier information may specify a list of individual class identifiers, e.g., {class identifier #1, class identifier #3}. In this case, {class identifier #1, class identifier #3} may specify involvement of public safety UEs with class identifiers #1 and #3 for an RPG formation. As another example, the class identifier information may specify individual class identifier by using a class bitmap. In particular, for an RPG formation, each bit of the class bitmap corresponds to a class identifier, and bit value “1” in a bit corresponding to class identifier #k indicates involvement of public safety UEs with class identifier #k, and bit value “0” in the bit corresponding to class identifier #k indicates no involvement of public safety UEs with class identifier #k. As another example, the class identifier information can specify a range of class identifiers assuming hierarchical class identifiers. For example, if the class identifier information indicates class identifier #k, Public safety UEs with class identifier that is equal to or higher than class identifier #k {i.e., class identifier≧class identifier #k} may be involved in an RPG formation. Alternatively, if the class identifier information specify class identifier #k, Public safety UEs with class identifier that is equal to or less than class identifier #k {i.e., class identifier≦class identifier #k} may be involved in the RPG formation. Alternatively, if the class identifier information indicates {class identifier #k, class identifier #j}, Public safety UEs with class identifier that is between class identifier #k and class identifier #j {i.e., class identifier #k≦class identifier-class identifier #j} may be involved in the RPG formation. The hierarchical class identifiers may be configured in view of urgency, safety level, authorization level, department relevancy, etc. The authorization level may include the indication of the application/service level that is allowed for the PSG. For example, assume that voice is level 1, data is level 2, video is level 3, and so on. In this case, if the authorization level for PSG #1 is 2, then the voice and data services are allowed for the PSG #1. Plural sets of hierarchical class identifiers may be configured per, e.g., situation or department. In this case, the class identifier information may further include information indicating which set of hierarchical class identifiers is used for the RPG formation.

As shown above, the public safety organization may manage MME and eNB(s) via the central control entity. The MME forwards RPG formation request from the central control entity to eNB(s) in target area. Then, eNB(s) may deliver information for RPG formation, as a part of a request message (hereinafter, RPG formation request #3), to UE(s), e.g., using a broadcast message and/or an overhead message (e.g., system parameter message, System Information Block (SIB), etc.) (S908). The RPG formation request #3 may include a list of class identifiers, bitmap of class identifiers, or range of class identifiers.

When the RPG formation request is transmitted via SIB, the RPG formation request may be transmitted as a part of system information blocks 10 and 11 as shown below tables.

TABLE 2
-- ASN1START
SystemInformationBlockType10 ::= SEQUENCE {

| messageIdentifier | BIT STRING (SIZE (16)), | |
|---|---|---|
| serialNumber | BIT STRING (SIZE (16)), | |
| warningType | OCTET STRING (SIZE (2)), | |
| warningSecurityInfo | OCTET STRING (SIZE (2)) | OPTIONAL, |
| lateNonCriticalExtension | OCTET STRING | OPTIONAL |
| Class identifier | {list, bitmap or range} | * Proposed * |

}
-- ASN1STOP

SystemInformationBlockType10 field description
messageIdentifier: identifies the source and type
of Earthquake and Tsunami Warning System
(ETWS) notification.
SerialNumber: identifies variations of an ETWS
notification.
WarningSecurityInfo: provides security information
for the ETWS
warningType: identifies the warning type of the
ETWS
Class identifier: identifies ProSe-enabled UEs for
an RPG formation regarding the ETWS

TABLE 3
-- ASN1START
SystemInformationBlockType11 ::= SEQUENCE {

| messageIdentifier | BIT STRING (SIZE (16)), | |
|---|---|---|
| serialNumber | BIT STRING (SIZE (16)), | |
| warningMessageSegmentType | ENUMERATED {notLastSegment, lastSegment}, | |
| warningMessageSegmentNumber | INTEGER (0..63), | |
| warningMessageSegment | OCTET STRING, | |
| dataCodingScheme | OCTET STRING (SIZE (1)) | OPTIONAL, |
| lateNonCriticalExtension | OCTET STRING | OPTIONAL |
| Class identifier | {list, bitmap or range} | * Proposed * |

}
-- ASN1STOP

SystemInformationBlockType11 field description
messageIdentifier: identifies the source and type
of Earthquake and Tsunami Warning System
(ETWS) notification.
serialNumber: identifies variations of an ETWS
notification.
warningMessageSegment: carries a segment of the
Warning Message Contents.
warningMessageSegmentNumber: segment number of
the ETWS warning message segment contained in the
SIB
dataCodingScheme: identifies the alphabet/coding
and the language applied variations of an
ETWS notification.
Class identifier: identifies ProSe-enabled UEs for
an RPG formation regarding the ETWS

UE(s) that are eligible for an RPG will initiate a discovery procedure for other UE(s) in the same RPG (S912). The discovery procedure for the RPG formation may be performed by using class identifier corresponding to the RPG. Then, the Public Safety UE may report the ProSe discovery information, including the neighboring ProSe node existence information, if detected, to the destination node, such as Central Control Entity (S914).

In the above example, the central control entity may belong to a public safety organization that operates a public safety network over the region or belong to a public safety organization that does not operate a public safety network over the region. For convenience, it is assumed that the public safety network is a public safety LTE network. Under this assumption, if the central control entity belongs to the public safety organization that operates the public safety network over the region, the public safety network entity may be, e.g., an MME for public safety LTE network, and the public safety radio entity may be an eNB for public safety LTE network. Meanwhile, if the central control entity belongs to the public safety organization that does not operate the public safety network over the region, the public safety network entity may be, e.g., an MME for Verizon Wireless LTE network, and the public safety radio entity may be an eNB for Verizon Wireless LTE network.

In addition, the central control entity can remove the restriction of forming the RPG based on the progress of the situations.

Profile-Based Method

FIG. 10 illustrates a signal flow diagram of RPG forming procedure in accordance with another example of the present invention. This method can be understood as an example of simplified version of network-based method in terms of “signaling burden”. Compared with the method of FIG. 9, the method of simplified version may need to send only “ignition (enable/disable)” information indication in signaling domain. Here, the profile may be a category. For example, the category may correspond to a set/combination of two or more class identifiers classified in view of situation, urgency, etc. A ProSe-enabled UE may have one or more profiles. The ProSe-enabled UE may be given a certain profile in an offline mode (e.g., stored when manufactured or stored before being dispatched) or in an online mode (e.g., broadcast (e.g., system information), multicast, and/or unicast). In the online mode, profile(s) may be indicated to a UE in a UE-specific way. Alternatively, a set of {class identifier(s), profile index} may be broadcast in a target area, and each UE may recognize its profile based on its class identifier and the set of {class identifier(s), profile index}.

With reference to FIG. 10, S1002˜S1008 and S1012˜S1014 are substantially corresponding to S902˜S908 and S912˜S914 of FIG. 9, except that the central control entity/MME/eNB needs to send/deliver only “ignition (enable/disable)” information indication. If the UE receives the ignition information indication from the eNB, the UE may check whether it belongs to a certain category so that it can perform RPG forming procedure or not, in particular, may check whether it matches with enabled profile(s) or not (S1008). The ignition information indication may be one-bit flag or a set of one-bit flags (e.g., bit-map). When a bit-map is used for ignition indication, each bit of the bitmap is used to enable/disable a corresponding profile. Profiles may be matched with the bit-map in increasing order of profile index. If profile indexes are configured non-consecutively, a bit corresponding to a vacant profile index may be included in the bit-map and set to a value indicating no-involvement in an RPG formation. In this case, the UE may be signaled about a total number of profiles in advance. Alternatively, if profile indexes are configured non-consecutively, a bit corresponding to a vacant profile index may not be included in the bit-map. In this case, the UE may be signaled about a relative order of a profile in advance. Information related with profile may be given in an offline mode (e.g., stored when manufactured or stored before being dispatched) or in an online mode (e.g., broadcast (e.g., system information), multicast, and/or unicast).

When the UE matches with enabled profile(s), the UE may perform discovery procedure and report discovery information to the network (S1012˜S1014). The discovery procedure may be performed using a profile index, an identifier inferred from the profile index, a class identifier corresponding to the profile index. If the discovery procedure is performed using a class identifier corresponding to a profile index, the eNB may inform a set of {class identifier(s), profile index} to the UE in advance.

As shown above, a simplified version of the “Network-Based Method” will save the signaling channel resources and therefore it is more reliable when the channel resource is congested or the channel quality is not good enough to support the “Network-Based Method”.

Multiple RPGs and Communicating Between RPGs

There is a situation that requires further division of public safety ProSe UEs within the same set of class identifier(s) to form separate RPGs. For example, two fires in New York downtown broke out close each other due to arson and two separate fire teams were working on each fire location. Each fire team belongs to a separate RPG, but there is a need to exchange information between two RPGs, e.g., progress of extinguishing the fires, for further back-up from one RPG to other RPG, etc. If RPGs are not located in proximity, then information from UE(s) in one RPG can be delivered to UE(s) in other RPG through a network. The network may be formed through an intermediate node(s) that has information on both the initiated RPG and the destined RPG. One possible example may be through a router in a police car that can act as a relay between two RPGs.

FIG. 11 illustrates a signal flow diagram for multiple RPG formation in accordance with another example of the present invention. Basic procedure is substantially identical with the methods in accordance with examples of FIGS. 9˜10, thus identical/similar operations are omitted in the below explanation in order to help understanding of the present invention.

With reference to FIG. 11, a network with ProSe capability may deliver (through broadcast, multicast, and/or unicast) ProSe RPG information, e.g., the number of RPGs, RPG identification(s), class identifier(s) of public safety UEs in each RPG, etc. over the region (S1102). From the ProSe RPG information, Public safety UE(s) in one RPG can know, e.g., how many RPGs are formed, RPG identification of each RPG, and/or class identifier(s) of public safety UEs in each RPG. Thus Public safety UE(s) in one RPG is able to discover other public safety UE(s) in other RPG(s) using RPG identification(s) belonging to other RPG(s) (S1104). RPG identification can be used for authentication purpose in communication between RPGs.

If public safety UE(s) in one RPG cannot discover target public safety UE(s) in other RPG (i.e., not located in proximity), then UE(s) may transmit a request message to the network for requesting a delivery of message(s) to the target public safety UE(s) in other RPG. The network may be formed through an intermediate node(s) that has information on both the initiated RPG and the destined RPG. One possible example may be through a router in a police car that can act as a relay between two RPGs. The request message can include the class identifier(s) of source and destination, intended message(s), etc. Alternatively, the request message can include the RPG identification(s) of source and destination, intended message(s), etc.

FIGS. 12˜13 illustrate signal flow diagrams for multiple RPG formation in accordance with another example of the present invention. FIGS. 12˜13 show cases that RPG leaders are specified by a network entity (e.g., the central control entity). Here, the RPG leader may mean a public safety UE representing an RPG. In particular, FIG. 12 shows a case for multiple RPG formation with one RPG leader per RPG, and FIG. 13 shows a case for multiple RPG formation with one RPG leader and one candidate substitute RPG leader (hereinafter, RPG leader 2) per RPG. Basic procedure is substantially identical with the method of FIG. 11, except that and (candidate substitute) RPG leader is specified, thus identical/similar operations are omitted in the below explanation.

With reference to FIG. 12, a network with ProSe capability may deliver (through broadcast, multicast, and/or unicast) ProSe RPG information, e.g., the number of RPGs, RPG identification(s), class identifier(s) of public safety UEs in each RPG, identification(s) of RPG leader(s) (RPG leader ID), etc. over the region (S1202). The ProSe RPG information may further include identification of one candidate substitute RPG leader per RPG (RPG leader 2 ID) (S1302). An RPG leader may be decided by a network side. For example, the central control entity can decide which public safety UE in each RPG will be a leader. Alternatively, an RPG leader may be decided through a negotiation of UEs in an RPG. In this case, each RPG (leader) can report a selected RPG leader to a central control entity and/or network operator(s). RPG leader can be changed due to some reasons, e.g., battery drains, etc. Information related with decision/modification of RPG leader can be delivered to other RPG leader(s).

When an RPG leader is configured in an RPG, Public safety UE(s) other than the RPG leader in the RPG can know the identification of the RPG leader. ProSe communications within the same RPG can be through the RPG leader (can be though as star topology). Alternatively, each public safety UE(s) in the same RPG can have multiple one-to-one ProSe communication links (can be though as mesh topology). Only, RPG leader(s) can find public safety UE(s) (in particular, RPG leader(s)) in other RPG(s). Accordingly, RPG leader(s) may discover and communicate with other RPGs' leader(s) using RPG leaders' identification(s) and RPG identification(s) (S1204, S1304). RPG identification and other RPG leaders' identification can be used for authentication purpose. If an RPG leader in one RPG cannot discover target RPG leader(s) in other RPG(s) (i.e., not located in proximity), then the RPG leader may transmit a request message to the network for requesting a delivery of message(s) to the target RPG leader(s) in other RPG(s). The request message can include RPG leaders' identifications of source and destination(s), intended message(s), etc.

Above methods can be thought of two topologies overlaid: (i) mesh topology (among RPG leader(s)) over star topologies (among public safety ProSe UE(s) in RPG(s)) or (ii) mesh topology (among RPG leader(s)) over mesh topologies (among public safety ProSe UE(s) in RPG(s)).

Proposed methods can be applied to various use cases. Table 2 shows exemplary use cases of an RPG for ProSe.

TABLE 4
Case 1: Restricted Public Safety ProSe Discovery within Network Coverage
1. Description

This use case describes the scenario where a given UE discovers one or more other UEs
from a set of UEs while in network coverage, with ProSe Discovery always enabled.

2. Pre-conditions

- An operator offers a service, which makes use of ProSe feature.
- Officer A has responsibility category X (e.g., immigration officer); Officers B, C, and D

have responsibility category Y.

- Officers B, C, and D are dispatched for on-going situation that belongs to category Y.
- Officer A, Officer B, Officer C, and Officer D use ProSe-enabled public safety UE's, and

are all within network coverage.

- Officer A is not in proximity to Officers B, C, and D, who are both within proximity of

each other.
3. Service flows

- Officer A moves into the proximity of Officers B, C, and D.
- Officer B's UE discovers Officer C and D's UE's upon entering proximity.
- Officer C's UE discovers Officer B and D's UE's upon entering proximity.
- Officer D's UE discovers Officer B and C's UE's upon entering proximity.
- Officer A's UE cannot discover Officers B, C, and D's UE's upon entering the proximity.

4. Post-conditions

None.

5. Requirements

- A ProSe-enabled UE that belongs to an RPG shall not be discoverable by any ProSe-

enabled UE that does not belong to that RPG.

- A ProSe-enabled public safety UE with ProSe Discovery enabled and configured to

discover other public safety UE's from the CPG shall be able to discover other discoverable
public safety UE's from the same CPG, under network coverage.

```
  Note 1: The details on who will manage RPM, RPG, including how to signal the setting or
  change of settings, are FFS.
  Note 2: A network operator can provide additional services for public safety UE's that are
  under network coverage, such as providing accurate location information through GPS
  data.
```

Case 2: UE with multiple one to one direct user traffic sessions in public safety
spectrum dedicated to ProSe services
1. Description

This use cases describes the case where a given UE can maintain one to one user traffic

sessions with multiple other UEs concurrently.
2. Pre-conditions

The preconditions are as in Section 5.2.1 with the addition of the following:
- Officer C uses a ProSe-enabled public safety device;
- Officer C is subscribed to a Public Safety service that allows it to use ProSe.

3. Service flows

- The three devices discover each other via ProSe Discovery.
- Officer A wants to communicate with Officers B and C concurrently.
- While Office A's and Officer B's devices exchange user traffic over a direct connection,

Officer A's device and Officer C's device are able to initiate an additional ProSe direct
connection and exchange user traffic over the air using the public safety spectrum.
4. Post-conditions

- Officer A communicates with Officer B, and C simultaneously.

5. Requirements

- In addition to the requirements indicated in section 5.2.1.5, the following applies:
A Public safety UE shall be capable of establishing one to one ProSe direct connection and

exchange user traffic with multiple other UEs concurrently, on public safety spectrum
dedicated to ProSe services, assuming they are in radio range, and are authorized.
* The above applies to ProSe-enabled UE's that belong to an RPG.

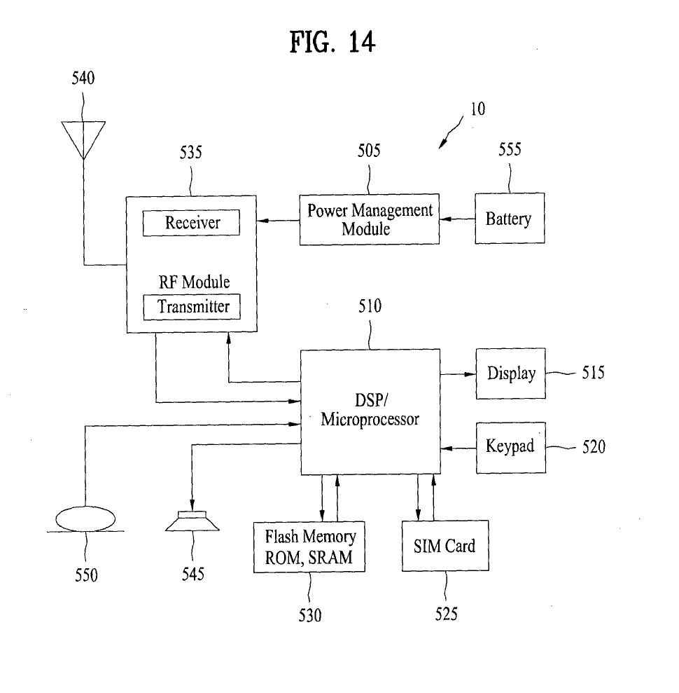

FIG. 14 illustrates a block diagram of a UE or Mobile Station (MS) 10. The UE 10 includes a ProSe-capable UE or a ProSe-enabled device. The UE 10 includes a processor (or digital signal processor) 510, RF module 535, power management module 505, antenna 540, battery 555, display 515, keypad 520, memory 530, SIM card 525 (which may be optional), speaker 545 and microphone 550.

A user enters instructional information, such as a telephone number, for example, by pushing the buttons of a keypad 520 or by voice activation using the microphone 550. The microprocessor 510 receives and processes the instructional information to perform the appropriate function, such as to dial the telephone number. Operational data may be retrieved from the Subscriber Identity Module (SIM) card 525 or the memory module 530 to perform the function. Furthermore, the processor 510 may display the instructional and operational information on the display 515 for the user's reference and convenience.

The processor 510 issues instructional information to the RF module 535, to initiate communication, for example, transmits radio signals comprising voice communication data. The RF module 535 comprises a receiver and a transmitter to receive and transmit radio signals. An antenna 540 facilitates the transmission and reception of radio signals. Upon receiving radio signals, the RF module 535 may forward and convert the signals to baseband frequency for processing by the processor 510. The processed signals would be transformed into audible or readable information outputted via the speaker 545, for example. The processor 510 also includes the protocols and functions necessary to perform the various processes described herein.

The aforementioned embodiments are achieved by combination of structural elements and features of the present invention in a predetermined fashion. Each of the structural elements or features should be considered selectively unless specified otherwise. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to the other claims other than the specific claims to constitute the embodiment or add new claims by means of amendment after the application is filed.

The embodiments of the present invention have been described based on data transmission and reception between a BS (or eNB) and a UE. A specific operation which has been described as being performed by the eNB (or BS) may be performed by an upper node of the BS (or eNB) as the case may be. In other words, it will be apparent that various operations performed for communication with the UE in the network which includes a plurality of network nodes along with the BS (or eNB) can be performed by the BS or network nodes other than the BS (or eNB). The BS may be replaced with terms such as fixed station, Node B, eNode B (eNB), and access point. Also, the term UE may be replaced with terms such as mobile station (MS) and mobile subscriber station (MSS).

The embodiments according to the present invention can be implemented by various means, for example, hardware, firmware, software, or combinations thereof. If the embodiment according to the present invention is implemented by hardware, the embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a module, a procedure, or a function, which performs functions or operations as described above. Software code may be stored in a memory unit and then may be driven by a processor. The memory unit may be located inside or outside the processor to transmit and receive data to and from the processor through various well known means.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention can be applied to a method and an apparatus for a proximity-based service, specifically, for forming a group(s) based on certain criteria in public safety situations and for cooperative discovery for the proximity-based service.

1. A method of performing a procedure of forming one or more Public Safety Groups (PSGs) for Proximity-based Service (ProSe) at a User Equipment (UE), wherein the UE has one or more configured class identifiers for the PSG, the method comprising:
receiving first information indicating one or more class identifiers as a part of system information from a network;
determining whether any one of the one or more configured class identifiers is indicated to be used as a specific class identifier for the PSG formation based on the first information in the system information; and
performing a procedure to discover one or more neighboring UEs for PSG formation using the specific identifier when any one of the one or more configured class identifiers is indicated as the specific class identifier for the PSG formation.

2. The method of claim 1, wherein the first information is received from a control entity related to public safety via a base station.

3. The method of claim 2, further comprising: transmitting information about one or more discovered neighboring UEs to the control entity related to public safety via the base station.

4. The method of claim 1, wherein the first information includes a bit map in which each bit is reserved for a corresponding class identifier, and one or more class identifiers corresponding to one or more bits set to a specific value are specific class identifiers for the PSG formation.

5. The method of claim 1, wherein the first information indicates a class identifier, and one or more class identifiers higher than the class identifier in the system information are specific class identifiers for the PSG formation.

6. The method of claim 1, further comprising: receiving second information indicating one or more group identifiers used to identify one or more PSGs, wherein two or more members of distinct PSGs communicate using the one or more group identifiers.

7. The method of claim 1, further comprising: receiving third information including identification information on one or more specific UEs for each PSG, wherein each of the one or more specific UEs act as a leader of a corresponding PSG.

8. The method of claim 1, further comprising: receiving fourth information indicting one or more authorization levels, wherein each authorization level is defined for a corresponding class identifier or a UE.

9. A UE configured to perform a procedure of forming a PSG for a ProSe, wherein the UE has one or more configured class identifiers for the PSG, the UE comprising:
a radio frequency (RF) unit; and
a processor, wherein the processor is configured:
to receive first information indicating one or more class identifiers as a part of system information from a network,
to determine whether any one of the one or more configured class identifiers is indicated to be used as a specific class identifier for the PSG formation based on the first information in the system information, and
to perform a procedure to discover one or more neighboring UEs for PSG formation using the specific identifier when any one of the one or more configured class identifiers is indicated as the specific class identifier for the PSG formation.

10. The UE of claim 9, wherein the first information is received from a control entity related to public safety via a base station.

11. The UE of claim 10, wherein the processor is further configured to: transmit information about one or more discovered neighboring user equipment to the control entity related to public safety via the base station.

12. The UE of claim 9, wherein the first information includes a bit map in which each bit is reserved for a corresponding class identifier, and one or more class identifiers corresponding to one or more bits set to a specific value are specific class identifiers for the PSG formation.

13. The UE of claim 9, wherein the first information indicates a class identifier, and one or more class identifiers higher than the class identifier in the system information are specific class identifiers for the PSG formation.

14. The UE of claim 9, wherein the processor is further configured to: receive second information indicating one or more group identifiers used to identify one or more PSGs, wherein two or more members of distinct PSGs communicate using the one or more group identifiers.

15. The UE of claim 9, wherein the processor is further configured to: receive third information including identification information on one or more specific UEs for each PSG, wherein each of the one or more specific UEs act as a leader of a corresponding PSG.

16. The UE of claim 9, wherein the processor is further configured to: receive fourth information indicting one or more authorization levels, wherein each authorization level is defined for a corresponding class identifier or a UE.
